(19) United States
(12) Patent Application Publication
(10) Pub. No.: US 2018/0099480 A1
(43) Pub. Date: Apr. 12, 2018

(54) LAMINATED FILM

(71) Applicant: FUJIFILM Corporation, Tokyo (JP)

(72) Inventors: Masayuki KUSUMOTO, Kanagawa (JP); Tatsuya OBA, Kanagawa (JP); Kyohisa UCHIUMI, Kanagawa (JP)

(73) Assignee: FUJIFILM Corporation, Tokyo (JP)

(21) Appl. No.: 15/840,417

(22) Filed: Dec. 13, 2017

Related U.S. Application Data
(63) Continuation of application No. PCT/JP2016/067814, filed on Jun. 15, 2016.

(30) Foreign Application Priority Data
Jun. 18, 2015 (JP) 2015-123272

(51) Int. Cl. B32B 7/02; B32B 27/06

(52) U.S. Cl. CPC B32B 7/02; B32B 2309/105; B32B 27/06

(57) ABSTRACT

The present invention provides a laminated film which has an optically functional layer such as a quantum dot layer and can prevent the optically functional layer from deteriorating due to oxygen or the like. The laminated film is provided with a laminate, in which a gas barrier layer is laminated on at least one surface of the optically functional layer, and a resin layer which covers an end face of the laminate, is formed of a composition containing a compound having at least one polymerizable functional group selected from a (meth)acryloyl group, a vinyl group, a glycidyl group, an oxetane group, and an alicyclic epoxy group in an amount of equal to or greater than 5 parts by mass provided that a total amount of solid contents of the composition is 100 parts by mass, and has an oxygen permeability of equal to or lower than 10 cc/(m²·day·atm).

### CROSS-REFERENCE TO RELATED APPLICATIONS

This application is a Continuation of PCT International Application No. PCT/JP2016/067814 filed on Jun. 15, 2016, which claims priority under 35 U.S.C. § 119(a) to Japanese Patent Application No. 2015-123272 filed on Jun. 18, 2015. The above application is hereby expressly incorporated by reference, in its entirety, into the present application.

### BACKGROUND OF THE INVENTION

### 1. Field of the Invention

The present invention relates to a laminated film used in a backlight of a liquid crystal display or the like.

### 2. Description of the Related Art

As an image display device that consumes less power and occupies a small space, a liquid crystal display (hereinafter, referred to as LCD as well) is increasingly widely used year after year. Furthermore, in recent years, for the liquid crystal display, a further reduction in power consumption, the enhancement of color reproducibility, and the like have been required as the improvement of LCD performance.

As the reduction in power consumption is required for LCD, in order to increase light use efficiency and enhance color reproducibility in a backlight (backlight unit), the use of a quantum dot (QD) which emits light by converting the wavelength of incidence rays in the backlight is suggested.

The quantum dot is in an electronic state of which the movement is restricted in all directions in a three-dimensional space. In a case where a semiconductor nanoparticle is three-dimensionally surrounded by a high-potential barrier, the nanoparticle becomes a quantum dot. The quantum dot exhibits various quantum effects. For example, the quantum dot exhibits “quantum size effect” in which the state density (energy level) of an electron becomes discrete. According to the quantum size effect, by changing the size of the quantum dot, the absorption wavelength⋅emission wavelength of light can be controlled.

Generally, by being dispersed in a matrix formed of a resin such as an acrylic resin or an epoxy resin, quantum dots are made into a quantum dot layer. For example, the quantum dot layer is used as a quantum dot film for wavelength conversion by being disposed between a backlight and a liquid crystal panel.

In a case where excitation light from a backlight is incident on the quantum dot film, the quantum dots are excited and emit fluorescence. At this time, in a case where quantum dots having different emission characteristics are used, light having a narrow half-width such as red light, green light, and blue light are emitted, and hence white light can be realized. Because the fluorescence from the quantum dots has a narrow half-width, by appropriately selecting the wavelength, it is possible to obtain white light with high luminance or to prepare a design so as to obtain excellent color reproducibility.

Incidentally, unfortunately, the quantum dots easily deteriorate due to oxygen or the like, and the emission intensity of the quantum dots deteriorates due to a photo-oxidation reaction. Therefore, in a quantum dot film, by laminating a gas barrier film on both surfaces of a quantum dot layer, the quantum dot layer is protected.

However, in a case where both surfaces of the quantum dot layer are simply sandwiched between gas barrier films, unfortunately, moisture or oxygen permeates the quantum dot layer from the end face not being covered with the gas barrier film, and hence the quantum dots deteriorate.

Accordingly, a method is suggested in which in addition to the both surfaces of a quantum dot layer, the periphery of the quantum dot layer is also sealed with a gas barrier film or the like.

For example, WO2012/102107A describes a composition obtained by dispersing quantum dot phosphors in a cycloolefin (co)polymer at a concentration within a range of 0.0% to 20% by mass, and describes a constitution including a gas barrier layer that coats the entire surface of a resin-molded material in which quantum dots formed of the aforementioned composition are dispersed. WO2012/102107A also describes that the gas barrier layer is a gas barrier film forming a silica film or an alumina film on at least one surface of the resin layer.

JP2013-544018A describes a backlight unit including a remote phosphor film containing an emission quantum dot (QD) aggregate, and describes a constitution in which a QD phosphor material is sandwiched between two gas barrier films, and an inert region having gas barrier properties is located in a region sandwiched between the two gas barrier films at the periphery around the QD phosphor material.

JP2009-283441A describes a light emitting device including a color conversion layer that converts at least a portion of colored light emitted from a light source portion into another colored light and an impermeable sealing sheet that seals the color conversion layer, and describes a constitution including a second adhesive layer provided in the form of a frame along the outer periphery of a phosphor layer that becomes the color conversion layer, that is, surrounding the planar shape of the phosphor layer, in which the second adhesive layer is formed of an adhesive material having gas barrier properties.

Furthermore, JP2010-61098A describes a quantum dot wavelength converter having a quantum dot layer (wavelength converting portion) and sealing members formed of silicone or the like that seals the quantum dot layer, and describes a constitution in which the quantum dot layer is sandwiched between the sealing members, and the sealing members are bonded to each other on the periphery of the quantum dot layer.

### SUMMARY OF THE INVENTION

LCD in which a quantum dot film is used as a backlight is used in various environments such as an indoor environment, an outdoor environment, and an in-vehicle environment. Furthermore, the backlight of LCD is heated due to the heat from a light source. In addition, for LCD used in vehicle, the backlight of LCD is likely to be exposed to an environment with a higher temperature and a higher humidity.

Accordingly, in the quantum dot film, it is required to seal the end face of a quantum dot layer such that sufficient gas barrier properties are exhibited which prevent oxygen or the like from permeating the quantum dot layer from the end face, and that the quantum dot film has sufficient durability even in an environment with a high temperature and a high humidity or the like.

However, in the quantum dot film of the related art in which the end face is sealed, it is difficult to obtain sufficient durability in an environment with a high temperature and a high humidity and to prevent the permeation of oxygen or the like from the end face of the quantum dot layer with sufficient gas barrier properties.

In addition, in a case where the sealing members are sealed together as shown in JP2010-61098A, the thickness of the quantum dot film varies in the plane direction, and accordingly, it is difficult to express sufficient optical characteristics.

The present invention is for solving the problems of the related art, and an object thereof is to provide a laminated film having an optically functional layer such as a quantum dot layer, in which a member such as a quantum dot performing an optical function can be prevented from deteriorating due to the permeation of oxygen or the like from an end face, and a sealing layer of the end face has sufficient durability even in an environment with a high temperature and a high humidity.

In order to achieve the aforementioned object, the present invention provides a laminated film comprising an optically functional layer, a gas barrier layer laminated on at least one main surface of the optically functional layer, and an end face sealing layer covering at least a portion of a cross section of a laminate end obtained by laminating the optically functional layer and the gas barrier layer, in which the end face sealing layer is a resin layer which is formed of a composition containing a polymerizable compound having at least one polymerizable functional group selected from a (meth)acryloyl group, a vinyl group, a glycidyl group, an oxetane group, and an alicyclic epoxy group in an amount of equal to or greater than 5 parts by mass provided that a total amount of solid contents of the composition is 100 parts by mass and has an oxygen permeability of equal to or lower than 10 cc/(m²·day·atm).

In the laminated film of the present invention, the end face sealing layer preferably covers the entirety of the end face of the laminate.

A logP value of a degree of hydrophilicity of the polymerizable compound contained in the composition forming the end face sealing layer is preferably equal to or smaller than 4.

The composition forming the end face sealing layer preferably contains a hydrogen bonding compound having the logP value of a degree of hydrophilicity of equal to or smaller than 4.

The composition forming the end face sealing layer preferably contains the hydrogen bonding compound in an amount of equal to or greater than 30 parts by mass provided that the total amount of solid contents of the composition is 100 parts by mass.

A thickness of the end face sealing layer is preferably 0.1 to 500 μm.

Particles of an inorganic substance are preferably dispersed in the end face sealing layer.

A size of the particles of an inorganic substance is preferably equal to or smaller than the thickness of the end face sealing layer.

According to the present invention, in the laminated film having an optically functional layer such as a quantum dot layer, the end face sealing layer sealing the end face can prevent a function material such as quantum dots from deteriorating due to the permeation of oxygen or the like from the end face of the optically functional layer, and the end face sealing layer has sufficient durability even in an environment with a high temperature and a high humidity. Therefore, the present invention can provide a laminated film such as a quantum dot film having long service life.

### BRIEF DESCRIPTION OF THE DRAWINGS

FIG. 1 is a cross-sectional view schematically showing an example of a laminated film of the present invention.

FIG. 2 is a cross-sectional view schematically showing an example of a gas barrier layer used in the laminated film of the present invention.

### DESCRIPTION OF THE PREFERRED EMBODIMENTS

Hereinafter, the laminated film and the method for manufacturing a laminated film of the present invention will be specifically described based on suitable examples shown in the attached drawings.

The following constituents will be described based on typical embodiments of the present invention in some cases, but the present invention is not limited to the embodiments.

In the present specification, a range of numerical values described using “to” means a range including the numerical values listed before and after “to” as a lower limit and an upper limit respectively.

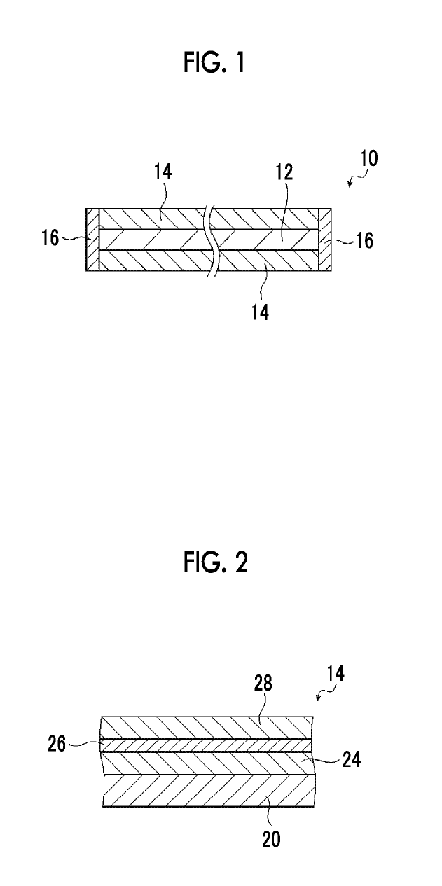

FIG. 1 is a cross-sectional view schematically showing an example of a laminated film of the present invention.

A laminated film 10 shown in FIG. 1 has an optically functional layer 12, gas barrier layers 14, and an end face sealing layer 16. As shown in FIG. 1, the laminated film 10 has a constitution in which the gas barrier layer 14 is laminated on both surfaces (both the main surfaces) of the sheet-like optically functional layer 12, and the entirety of the end face of the laminate obtained by sandwiching the optically functional layer 12 between the gas barrier layers 14 is covered with the end face sealing layer 16.

As will be specifically described later, the end face sealing layer 16 is a resin layer having an oxygen permeability of equal to or lower than 10 cc/(m²·day·atm).

The optically functional layer 12 is a layer for performing a desired function such as wavelength conversion, and a sheet-like material having a quadrangular planar shape, for example. In the following description, “optically functional layer 12” will be referred to as “functional layer 12” as well.

As the functional layer 12, it is possible to use various layers performing optical functions, such as a wavelength conversion layer like a quantum dot layer, a light extraction layer, and an organic electro luminescence layer (organic EL layer).

Particularly, by having the end face sealing layer 16, the functional layer 12 enables the characteristics of the laminated film of the present invention to be sufficiently exhibited, such as being able to prevent an optically functional material from deteriorating due to oxygen permeating from the end face and sufficient durability of the end face sealing layer 16 that is exhibited even at a high temperature and a high humidity. Therefore, a quantum dot layer, which is used in LCD or the like assumed to be used in various environments such as an in-vehicle environment with a high temperature and a high humidity and in which the deterioration of quantum dots resulting from oxygen becomes a big issue, can be suitably used as the functional layer 12.

For example, the quantum dot layer is a layer obtained by dispersing a large number of quantum dots in a matrix such as a resin, and is a wavelength conversion layer having a function of converting the wavelength of light incident on the functional layer 12 and emitting the light.

For example, in a case where blue light emitted from a backlight not shown in the drawing is incident on the functional layer 12, by the effect of the quantum dots contained in the optically functional layer 12, the functional layer 12 performs wavelength conversion such that at least a portion of the blue light becomes red light or green light and emits the light.

Herein, the blue light refers to light having an emission wavelength centered at a wavelength range of 400 to 500 nm, the green light refers to light having an emission wavelength centered at a wavelength range of a wavelength of longer than 500 nm to a wavelength of 600 nm, and the red light refers to light having an emission wavelength centered at a wavelength range of a wavelength of longer than 600 nm to a wavelength of equal to or shorter than 680 nm.

The function of wavelength conversion that the quantum dot layer performs is not limited to the constitution in which the wavelength conversion is performed to change the blue light into the red light or the green light, and at least a portion of incidence rays may be converted into light having a different wavelength.

The quantum dot emits fluorescence by being excited with at least excitation light incident thereon.

The type of the quantum dot contained in the quantum dot layer is not particularly limited, and according to the required wavelength conversion performance or the like, various known quantum dots may be appropriately selected.

Regarding the quantum dot, for example, paragraphs “0060” to “0066” in JP2012-169271A can be referred to, but the present invention is not limited thereto. As the quantum dot, commercially available products can be used without restriction. Generally, the emission wavelength of the quantum dot can be adjusted by the composition or size of the particles.

Although it is preferable that quantum dots are evenly dispersed in a matrix, the quantum dots may be unevenly dispersed in the matrix.

Furthermore, one kind of quantum dot may be used singly, or two or more kinds of quantum dots may be used in combination.

In a case where two or more kinds of quantum dots are used in combination, quantum dots that emit light having different wavelengths may be used.

Specifically, known quantum dots include a quantum dot (A) having an emission wavelength centered at a wavelength range of 600 to 680 nm, a quantum dot (B) having an emission wavelength centered at a wavelength range of 500 to 600 nm, and a quantum dot (C) having a emission wavelength centered at a wavelength range of 400 to 500 nm. The quantum dot (A) emits red light by being excited with excitation light, the quantum dot (B) emits green light, and the quantum dot (C) emits blue light. For example, in a case where blue light is caused to incident on a quantum dot-containing laminate containing the quantum dot (A) and the quantum dot (B) as excitation light, by the red light emitted from the quantum dot (A), the green light emitted from the quantum dot (B), and the blue light transmitted through the quantum dot layer, white light can be realized. Furthermore, in a case where ultraviolet light is caused to incident on the quantum dot layer containing the quantum dots (A), (B), and (C) as excitation light, by the red light emitted from the quantum dot (A), the green light emitted from the quantum dot (B), and the blue light emitted from the quantum dot (C), white light can be realized.

As a quantum dot, a so-called quantum rod which has a rod shape and emits polarized light with directionality may be used.

The type of the matrix of the quantum dot layer is not particularly limited, and various resins used in known quantum dot layers can be used.

Examples of the matrix include a polyester-based resin (for example, polyethylene terephthalate and polyethylene naphthalate), a (meth)acrylic resin, a polyvinyl chloride-based resin, a polyvinylidene chloride-based resin, and the like. Alternatively, as the matrix, it is possible to use a curable compound having a polymerizable group. The type of the polymerizable group is not particularly limited, but the polymerizable group is preferably a (meth)acrylate group, a vinyl group, or an epoxy group, more preferably a (meth)acrylate group, and particularly preferably an acrylate group. In a polymerizable monomer having two or more polymerizable groups, the polymerizable groups may be the same as or different from each other.

Specifically, for example, a resin containing a first polymerizable compound and a second polymerizable compound described below can be used as a matrix.

The first polymerizable compound is preferably one or more compounds selected from the group consisting of a (meth)acrylate monomer having two or more functional groups and a monomer having two or more functional groups selected from the group consisting of an epoxy group and an oxetanyl group.

Examples of the (meth)acrylate monomer having two or more functional groups preferably include difunctional (meth)acrylate monomers such as neopentyl glycol di(meth)acrylate, 1,9-nonanediol di(meth)acrylate, tripropylene glycol di(meth)acrylate, ethylene glycol di(meth)acrylate, tetraethylene glycol di(meth)acrylate, hydroxypivalic acid neopentyl glycol di(meth)acrylate, polyethylene glycol di(meth)acrylate, dicyclopentenyl (meth)acrylate, dicyclopentenyloxyethyl (meth)acrylate, and dicyclopentanyl di(meth)acrylate.

Examples of the (meth)acrylate monomer having two or more functional groups preferably include (meth)acrylate monomers having three or more functional groups such as epichlorohydrin (ECH)-modified glycerol tri(meth)acrylate, ethylene oxide (EO)-modified glycerol tri(meth)acrylate, propylene oxide (PO)-modified glycerol tri(meth)acrylate, pentaerythritol triacrylate, pentaerythritol tetraacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl)isocyanurate, dipentaerythritol hexa(meth)acrylate, dipentaerythritol penta(meth)acrylate, caprolactone-modified dipentaerythritol hexa(meth)acrylate, dipentaerythritol hydroxypenta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy tetra(meth)acrylate, and pentaerythritol tetra(meth)acrylate.

As the monomer having two or more functional groups selected from the group consisting of an epoxy group and an oxetanyl group, an aliphatic cyclic epoxy compound, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers; polyglycidyl ethers of polyether polyol obtained by adding one kind or two or more kinds of alkylene oxide to an aliphatic polyhydric alcohol such as ethylene glycol, propylene glycol, or glycerin; diglycidyl esters of aliphatic long-chain dibasic acid; glycidyl esters of higher fatty acids; a compound containing epoxycycloalkane, and the like are suitably used.

Examples of commercially available products that can be suitably used as the monomer having two or more functional groups selected from the group consisting of an epoxy group and an oxetanyl group include CELLOXIDE 2021P and CELLOXIDE 8000 manufactured by Daicel Corporation, 4-vinylcyclohexene dioxide manufactured by Sigma-Aldrich Co. LLC., and the like. One kind of these monomers can be used singly, or two or more kinds of these monomers can be used in combination.

The monomer having two or functional groups selected from the group consisting of an epoxy group and an oxetanyl group may be prepared by any method. For example, the monomer can be synthesized with reference to the documents such as “Experimental Chemistry Course 20, Organic Synthesis II”, pp. 213˜, 1992, MARUZEN SHUPPAN K. K. “The chemistry of heterocyclic compounds-Small Ring Heterocycles, part 3 Oxiranes”, Ed. By Alfred Hasfner, 1985, John & Wiley and sons, An Interscience Publication, New York, 1985, “Adhesion”, Yoshimura, Vol. 29, No. 12, 32, 1985, “Adhesion”, Yoshimura, Vol. 30, No. 5, 42, 1986, “Adhesion”, Yoshimura, Vol. 30, No. 7, 42, 1986, JP1999-100378A (JP-H11-100378A), JP2906245B, and JP2926262B.

The second polymerizable compound contains a functional group which has hydrogen bonding properties in a molecule and a polymerizable group which can cause a polymerization reaction with the first polymerizable compound.

Examples of the functional group having hydrogen bonding properties include a urethane group, a urea group, a hydroxyl group, and the like.

In a case where the first polymerizable compound is a (meth)acrylate monomer having two or more functional groups, the polymerizable group which can cause a polymerization reaction with the first polymerizable compound may be a (meth)acryloyl group, for example. In a case where the first polymerizable compound is a monomer having two or more functional groups selected from the group consisting of an epoxy group and an oxetanyl group, the polymerizable group which can cause a polymerization reaction may be an epoxy group or an oxetanyl group.

Examples of the (meth)acrylate monomer containing a urethane group include monomers and oligomers obtained by reacting diisocyanate such as tolylene diisocyanate (TDI), diphenylmethane diisocyanate (MDI), hexamethylene diisocyanate (HDI), isophorone diisocyanate (IPDI), and hydrogenated MDI (HMDI) with polyol such as poly(propyleneoxide)diol, poly(tetramethyleneoxide)diol, ethoxylated bisphenol A, ethoxylated bisphenol S spiroglycol, caprolactone-modified diol, and carbonate diol and hydroxyacrylate such as 2-hydroxyethyl (meth)acrylate, 2-hydroxypropyl (meth)acrylate, glycidol di(meth)acrylate, and pentaerythritol triacrylate, and polyfunctional urethane monomers described in JP2002-265650A, JP2002-355936A, JP2002-067238A, and the like. Specifically, examples thereof include an adduct of TDI and hydroxyethyl acrylate, an adduct of IPDI and hydroxyethyl acrylate, an adduct of HDI and pentaerythritol triacrylate (PETA), a compound obtained by making an adduct of TDI and PETA and reacting the remaining isocyanate with dodecyloxyhydroxypropyl acrylate, an adduct of 6,6 nylon and TDI, an adduct of pentaerythritol, TDI, and hydroxyethyl acrylate, and the like, but the present invention is not limited to these.

Examples of commercially available products that can be suitably used as the (meth)acrylate monomer containing a urethane group include AH-600, AT-600, UA-306H, UA-306T, UA-306I, UA-510H, UF-8001G, and DAUA-167 manufactured by KYOEISHA CHEMICAL Co., LTD, UA-160TM manufactured by SHIN-NAKAMURA CHEMICAL CO., LTD., UV-4108F and UV-4117F manufactured by OSAKA ORGANIC CHEMICAL INDUSTRY LTD, and the like. One kind of these monomers can be used singly, or two or more kinds of these monomers can be used in combination.

Examples of the (meth)acrylate monomer containing a hydroxyl group include a compound synthesized by causing a reaction between a compound having an epoxy group and (meth)acrylic acid. Typical examples of the monomer are classified into, depending on the compound having an epoxy group, a bisphenol A type, a bisphenol S type, a bisphenol F type, an epoxidized oil type, a phenol novolac type, and alicyclic type. Specific examples of the monomer include (meth)acrylate obtained by reacting an adduct of bisphenol A and epichlorohydrin with (meth)acrylic acid, (meth)acrylate obtained by reacting phenol novolac with epichlorohydrin and then reacting the product with (meth)acrylic acid, (meth)acrylate obtained by reacting an adduct of bisphenol S and epichlorohydrin with (meth)acrylic acid, (meth)acrylate obtained by reacting epoxidized soybean oil with (meth)acrylic acid, and the like. Examples of the (meth)acrylate monomer containing a hydroxyl group also include a (meth)acrylate monomer having a carboxyl group or a phosphoric acid group on the terminal, and the like, but the present invention is not limited thereto.

Examples of commercially available products that can be suitably used as the second polymerizable compound containing a hydroxyl group include epoxy ester, M-600A, 40EM, 70PA, 200PA, 80MFA, 3002M, 3002A, 3000MK, and 3000A manufactured by KYOEISHA CHEMICAL Co., LTD, 4-hydroxybutyl acrylate manufactured by Nippon Kasei Chemical Co., Ltd, monofunctional acrylate A-SA and monofunctional methacrylate SA manufactured by SHIN-NAKAMURA CHEMICAL CO., LTD., monofunctional acrylate β-carboxyethyl acrylate manufactured by DAICEL-ALLNEX LTD., JPA-514 manufactured by JOHOKU CHEMICAL CO., LTD, and the like. One kind of these can be used singly, or two or more kinds of these can be used in combination.

A mass ratio of first polymerizable compound: second polymerizable compound may be 10:90 to 99:1, and is preferably 10:90 to 90:10. It is preferable that the content of the first polymerizable compound is greater than the content of the second polymerizable compound. Specifically, (content of first polymerizable compound)/(content of second polymerizable compound) is preferably 2 to 10.

In a case where a resin containing the first polymerizable compound and the second polymerizable compound is used as a matrix, it is preferable that the matrix further contains a monofunctional (meth)acrylate monomer. Examples of the monofunctional (meth)acrylate monomer include acrylic acid, methacrylic acid, and derivatives of these, and more specifically include a monomer having one polymerizable unsaturated bond ((meth)acryloyl group) of (meth)acrylic acid in a molecule. Specific examples of the monomer include the following compounds, but the present invention is not limited thereto.

Examples of the monomer include alkyl (meth)acrylate containing an alkyl group having 1 to 30 carbon atoms such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, and stearyl (meth)acrylate; aralkyl (meth)acrylate containing an aralkyl group having 7 to 20 carbon atoms, such as benzyl (meth)acrylate; alkoxyalkyl (meth)acrylate containing an alkoxyalkyl group having 2 to 30 carbon atoms, such as butoxyethyl (meth)acrylate; aminoalkyl (meth)acrylate containing a (monoalkyl or dialkyl) aminoalkyl group having 1 to 20 carbon atoms in total, such as N,N-dimethylaminoethyl (meth)acrylate; (meth)acrylate of polyalkylene glycol alkyl ether containing an alkylene chain having 1 to 10 carbon atoms and terminal alkyl ether having 1 to 10 carbon atoms, such as (meth)acrylate of diethylene glycol ethyl ether, (meth)acrylate of triethylene glycol butyl ether, (meth)acrylate of tetraethylene glycol monomethyl ether, (meth)acrylate of hexaethylene glycol monomethyl ether, monomethyl ether (meth)acrylate of octaethylene glycol, monomethyl ether (meth)acrylate of nonaethylene glycol, monomethyl ether (meth)acrylate of dipropylene glycol, monomethyl ether (meth)acrylate of heptapropylene glycol, and monoethyl ether (meth)acrylate of tetraethylene glycol; (meth)acrylate of polyalkylene glycol aryl ether containing an alkylene chain having 1 to 30 carbon atoms and terminal aryl ether having 6 to 20 carbon atoms, such as (meth)acrylate of hexaethylene glycol phenyl ether; (meth)acrylate having an alicyclic structure containing 4 to 30 carbon atoms in total, such as cyclohexyl (meth)acrylate, dicyclopentanyl (meth)acrylate, isobornyl (meth)acrylate, and methylene oxide-added cyclodecatriene (meth)acrylate; fluorinated alkyl (meth)acrylate having 4 to 30 carbon atoms in total such as heptadecafluorodecyl (meth)acrylate; (meth)acrylate having a hydroxyl group such as 2-hydroxyethyl (meth)acrylate, 3-hydroxypropyl (meth)acrylate, 4-hydroxybutyl (meth)acrylate, mono(meth)acrylate of triethylene glycol, tetraethylene glycol mono(meth)acrylate, hexaethylene glycol mono(meth)acrylate, octapropylene glycol mono(meth)acrylate, and mono- or di(meth)acrylate of glycerol; (meth)acrylate having a glycidyl group such as glycidyl (meth)acrylate; polyethylene glycol mono(meth)acrylate having an alkylene chain containing 1 to 30 carbon atoms, such as tetraethylene glycol mono(meth)acrylate, hexaethylene glycol mono(meth)acrylate, and octapropylene glycol mono(meth)acrylate; (meth)acrylamide such as (meth)acrylamide, N,N-dimethyl (meth)acrylamide, N-isopropyl (meth)acrylamide, 2-hydroxyethyl (meth)acrylamide, and acryloylmorpholine; and the like.

The content of the monofunctional (meth)acrylate monomer with respect to the total mass (100 parts by mass) of the first polymerizable compound and the second polymerizable compound is preferably 1 to 300 parts by mass, and more preferably 50 to 150 parts by mass.

Furthermore, it is preferable that the matrix contains a compound having a long-chain alkyl group containing 4 to 30 carbon atoms. Specifically, it is preferable that at least any one of the first polymerizable compound, the second polymerizable compound, or the monofunctional (meth)acrylate monomer has a long-chain alkyl group having 4 to 30 carbon atoms. It is preferable that long-chain alkyl group is a long-chain alkyl group having 12 to 22 carbon atoms, because then the dispersibility of the quantum dots is improved. The further the dispersibility of the quantum dots is improved, the further the amount of light that goes straight to an emission surface from a light conversion layer increases. Accordingly, the improvement of the dispersibility of the quantum dots is effective for improving front luminance and front contrast.

Specifically, as the monofunctional (meth)acrylate monomer having a long-chain alkyl group containing 4 to 30 carbon atoms, butyl (meth)acrylate, octyl (meth)acrylate, lauryl (meth)acrylate, oleyl (meth)acrylate, stearyl (meth)acrylate, behenyl (meth)acrylate, butyl (meth)acrylamide, octyl (meth)acrylamide, lauryl (meth)acrylamide, oleyl (meth)acrylamide, stearyl (meth)acrylamide, behenyl (meth)acrylamide, and the like are preferable. Among these, lauryl (meth)acrylate, oleyl (meth)acrylate, and stearyl (meth)acrylate are particularly preferable.

Furthermore, the resin which becomes a matrix may contain a compound having a fluorine atom such as trifluoroethyl (meth)acrylate, pentafluoroethyl (meth)acrylate, (perfluorobutyl)ethyl (meth)acrylate, perfluorobutyl-hydroxypropyl (meth)acrylate, (perfluorohexyl)ethyl (meth)acrylate, octafluoropentyl (meth)acrylate, perfluorooctyl ethyl (meth)acrylate, and tetrafluoropropyl (meth)acrylate. In a case where the resin contains these compounds, the coating properties can be further improved.

The total amount of the resin, which becomes a matrix, in the quantum dot layer is not particularly limited. The total amount of the resin with respect to a total of 100 parts by mass of the quantum dot layer is preferably 90 to 99.9 parts by mass, and more preferably 92 to 99 parts by mass.

The thickness of the quantum dot layer may be appropriately set according to the thickness of the laminated film 10 or the like. According to the examination performed by the inventors of the present invention, in view of handleability and emission characteristics, the thickness of the quantum dot layer is preferably 5 to 200 μm, and more preferably 10 to 150 μm.

The aforementioned thickness means an average thickness which can be determined by measuring thicknesses of ten or more random spots in the quantum dot layer and calculating an arithmetic mean thereof.

The method for forming the quantum dot layer is not particularly limited, and the quantum dot layer may be formed by a known method. For example, the quantum dot layer can be formed by preparing a composition (paint⋅coating composition) by means of mixing quantum dots, a resin which becomes a matrix, and a solvent together, coating the gas barrier layer 14 with the composition, and curing the composition.

If necessary, a polymerization initiator, a silane coupling agent, and the like may be added to the composition that will become the quantum dot layer.

In the laminated film 10, on both surfaces of the functional layer 12 such as a quantum dot layer, the gas barrier layer 14 is laminated such that the entirety of the main surfaces of the functional layer 12 is covered. That is, the laminated film 10 has a constitution in which the functional layer 12 is sandwiched between the gas barrier layers 14.

Herein, as a preferred aspect, the laminated film 10 shown in the drawing includes the gas barrier layer 14 provided on both surfaces of the functional layer 12, but the present invention is not limited thereto. That is, the gas barrier layer 14 may be provided on only one surface of the functional layer 12. However, it is preferable that the gas barrier layer 14 is provided on both surfaces of the functional layer 12, because then the deterioration of the functional layer 12 resulting from oxygen or the like can be more suitably prevented.

In a case where the gas barrier layer 14 is provided on both surfaces of the functional layer 12, the gas barrier layers 14 may be the same as or different from each other.

The gas barrier layer 14 is a layer for inhibiting the permeation of oxygen or the like from the main surface of the functional layer 12 such as a quantum dot layer. Accordingly, it is preferable that the gas barrier layer 14 has high gas barrier properties. Specifically, an oxygen permeability of the gas barrier layer 14 is preferably equal to or lower than 0.1 cc(m²·day·atm), more preferably equal to or lower than 0.01 cc/(m²·day·atm), and particularly preferably equal to or lower than 0.001 cc/(m²·day·atm).

In a case where the oxygen permeability of the gas barrier layer 14 is equal to or lower than 0.1 cc/(m²·day·atm), it is possible to inhibit the functional layer 12 from deteriorating due to oxygen or the like permeating from the main surface of the functional layer 12 and to obtain a laminated film such as a quantum dot film having long service life.

In the present invention, the oxygen permeability of the gas barrier layer 14, the end face sealing layer 16, or the like may be measured based on examples which will be described later.

As the gas barrier layer 14, various materials such as a layer (film) formed of a known material exhibiting gas barrier properties and a known gas barrier film can be used, as long as the materials have sufficient optical characteristics in view of transparency or the like and yield intended gas barrier properties (oxygen barrier properties).

Particularly, as a preferred gas barrier layer 14, a gas barrier film can be exemplified which has an organic and inorganic laminated structure obtained by alternately laminating an organic layer and an inorganic layer on a support. In this gas barrier film, the organic and inorganic laminated structure may be formed on only one surface of the support or on both surfaces of the support.

FIG. 2 schematically shows a cross-section of an example of the gas barrier layer 14.

The gas barrier layer 14 shown in FIG. 2 has an organic layer 24 on a support 20, an inorganic layer 26 on the organic layer 24, and an organic layer 28 on the inorganic layer 26.

In the gas barrier layer 14 (gas barrier film), gas barrier properties are mainly exhibited by the inorganic layer 26. The organic layer 24 as an underlayer of the inorganic layer 26 is an underlayer for appropriately forming the inorganic layer 26. The organic layer 28 as an uppermost layer functions as a protective layer for the inorganic layer 26.

In the laminated film of the present invention, the gas barrier film, which is used as the gas barrier layer 14 and has an organic and inorganic laminated structure, is not limited to the example shown in FIG. 2.

For example, the gas barrier layer 14 may not have the organic layer 28 as an uppermost layer that functions as a protective layer.

Furthermore, although the gas barrier layer 14 in example shown in FIG. 2 has only one combination of the inorganic layer and the organic layer as a base, the gas barrier layer 14 may have two or more combinations of the inorganic layer and the organic layer as a base. Generally, the larger the number of combinations of the inorganic layer and the organic layer as a base, the higher the gas barrier properties.

In addition, a constitution may be adopted in which an inorganic layer is formed on the support 20, and one or more combinations of an inorganic layer and an organic layer as a base are provided on the aforementioned inorganic layer.

As the support 20 of the gas barrier layer 14, it is possible to use various materials that are used as a support in known gas barrier films.

Among these, films formed of various resin materials (polymer materials) are suitably used, because these films make it easy to obtain a thin or lightweight support and are suitable for making a flexible support.

Specifically, plastic films formed of polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, a polymethyl methacrylate resin (PMMA), polycarbonate (PC), polyacrylate, polymethacrylate, polypropylene (PP), polystyrene (PS), ABS, a cycloolefin copolymer (COC), a cycloolefin polymer (COP), and triacetyl cellulose (TAC) can be suitably exemplified.

The thickness of the support 20 may be appropriately set according to the thickness, size, and the like of the laminated film 10. According to the examination performed by the inventors of the present invention, the thickness of the support 20 is preferably about 10 to 100 μm. In a case where the thickness of the support 20 is within the above range, in view of making a lightweight or thin support, preferable results are obtained.

To the surface of the plastic film of which the support 20 is formed, the functions of preventing reflection, controlling phase difference, improving light extraction efficiency, and the like may be imparted.

In the gas barrier layer 14, the organic layer 24 is formed on the surface of the support 20.

The organic layer 24 formed on the surface of the support 20, that is, the organic layer 24 which becomes an underlayer of the inorganic layer 26 is an underlayer of the inorganic layer 26 mainly exhibiting gas barrier properties in the gas barrier layer 14.

In a case where the gas barrier layer 14 has the organic layer 24, the surface asperities of the support 20, foreign substances having adhered to the surface of the support 20, and the like are concealed, and hence a deposition surface for the inorganic layer 26 can be in a state suitable for forming the inorganic layer 26. Accordingly, it is possible to form an appropriate inorganic layer 26 without voids on the entire surface of the substrate, by removing regions, on which an inorganic compound that becomes the inorganic layer 26 is not easily deposited as a film, such as surface asperities or shadows of foreign substances on the support 20. As a result, a gas barrier layer 14 having an oxygen permeability of equal to or lower than 0.1 cc/(m²·day·atm) can be stably formed.

In the gas barrier layer 14, as the material for forming the organic layer 24, various known organic compounds can be used without restriction.

Specifically, thermoplastic resins such as polyester, a (meth)acrylic resin, a methacrylic acid-maleic acid copolymer, polystyrene, a transparent fluorine resin, polyimide, fluorinated polyimide, polyamide, polyamide imide, polyether imide, cellulose acylate, polyurethane, polyether ether ketone, polycarbonate, alicyclic polyolefin, polyarylate, polyether sulfone, polysulfone, fluorene ring-modified polycarbonate, alicyclic ring-modified polycarbonate, fluorene ring-modified polyester, and an acryl compound, polysiloxane, and films of other organic silicon compounds can be suitably exemplified. A plurality of these materials may be used in combination.

Among these, in view of excellent glass transition temperature or hardness, an organic layer 24 is suitable which is constituted with a polymer of a radically curable compound and/or a cationically curable compound having an ether group as a functional group.

Particularly, an acrylic resin or a methacrylic resin, which contains a polymer of a monomer or an oligomer of acrylate and/or methacrylate as a main component, can be suitably exemplified as the organic layer 24, because such a resin has low refractive index, high transparency, excellent optical characteristics, and the like.

Especially, an acrylic resin or a methacrylic resin can be suitably exemplified which contains, as a main component, a polymer of a monomer or an oligomer of acrylate and/or methacrylate having two or more functional groups, particularly, three or more functional groups, such as dipropylene glycol di(meth)acrylate (DPGDA), trimethylolpropane tri(meth)acrylate (TMPTA), or dipentaerythritol hexa(meth)acrylate (DPHA). Furthermore, it is preferable to use a plurality of acrylic resins or methacrylic resins described above.

The thickness of the organic layer 24 may be appropriately set according to the material for forming the organic layer 24 or the support 20. According to the examination performed by the inventors of the present invention, the thickness of the organic layer 24 is preferably 0.5 to 5 μm, and more preferably 1 to 3 μm.

In a case where the thickness of the organic layer 24 is equal to or greater than 0.5 μm, the surface of the organic layer 24, that is, the deposition surface for the inorganic layer 26 can be smoothed by concealing the surface asperities of the support 20 or the foreign substances having adhered to the surface of the support 20. In a case where the thickness of the organic layer 24 is equal to or smaller than 5 μm, it is possible to suitably inhibit the occurrence of problems such as cracking of the organic layer 24 caused in a case where the organic layer 24 is too thick and curling caused by the gas barrier layer 14.

In a case where the gas barrier film has a plurality of organic layers, such as a case where the gas barrier film has a plurality of combinations of an inorganic layer and an organic layer as a base, the organic layers may have the same thickness or different thicknesses.

The organic layer 24 may be formed by a known method such as a coating method or a flash vapor deposition method.

In order to improve the adhesiveness between the organic layer 24 and the inorganic layer 26 that becomes the underlayer of the organic layer 24, it is preferable that the organic layer 24 (composition that becomes the organic layer 24) contains a silane coupling agent.

In a case where the gas barrier film has a plurality of organic layers 24, such as a case where the gas barrier film has a plurality of combinations of an inorganic layer and an organic layer as a base including the organic layer 28 which will be described later, the organic layers may be formed of the same material or different materials. However, in view of productivity and the like, it is preferable that all the organic layers are formed of the same material.

On the organic layer 24, the inorganic layer 26 is formed using the organic layer 24 as a base.

The inorganic layer 26 is a film containing an inorganic compound as a main component and mainly exhibits gas bather properties in the gas barrier layer 14.

As the inorganic layer 26, various films can be used which exhibit gas barrier properties and are formed of an inorganic compound such as an oxide, a nitride, or an oxynitride.

Specifically, films formed of inorganic compounds including a metal oxide such as aluminum oxide, magnesium oxide, tantalum oxide, zirconium oxide, titanium oxide, an indium tin oxide (ITO); a metal nitride such as aluminum nitride; a metal carbide such as aluminum carbide; an oxide of silicon such as silicon oxide, silicon oxynitride, silicon oxycarbide, and silicon oxynitrocarbide; a nitride of silicon such as silicon nitride and silicon nitrocarbide; a carbide of silicon such as silicon carbide; hydroxides of these; a mixture of two or more kinds of these; and hydrogenous substances of these can be suitably exemplified.

Particularly, films formed of a silicon compound such as an oxide of silicon, a nitride of silicon, and an oxynitride of silicon can be suitably exemplified, because these films have high transparency and can exhibit excellent gas barrier properties. Among these, a film formed of silicon nitride can be particularly suitably exemplified because this film exhibits better gas barrier properties and has high transparency.

The thickness of the inorganic layer 26 may be appropriately determined according to the material for forming the inorganic layer 26, such that intended gas barrier properties can be exhibited. According to the examination performed by the inventors of the present invention, the thickness of the inorganic layer 26 is preferably 10 to 200 nm, more preferably 10 to 100 nm, and particularly preferably 15 to 75 nm.

In a case where the thickness of the inorganic layer 26 is equal to or greater than 10 nm, an inorganic layer 26 stably demonstrating a sufficient gas barrier performance can be formed. Generally, in a case where the inorganic layer 26 is brittle and too thick, the inorganic layer 26 is likely to experience cracking, fissuring, peeling and the like. However, in a case where the thickness of the inorganic layer 26 is equal to or smaller than 200 nm, the occurrence of cracks can be prevented.

In a case where the gas barrier film has a plurality of inorganic layers 26, the inorganic layers 26 may have the same thickness or different thicknesses.

The inorganic layer 26 may be formed by a known method according to the material forming the inorganic layer 26. Specifically, plasma CVD such as capacitively coupled plasma (CCP)-chemical vapor deposition (CVD) or inductively coupled plasma (ICP)-CVD, sputtering such as magnetron sputtering or reactive sputtering, and a vapor-phase deposition method such as vacuum vapor deposition can be suitably exemplified.

In a case where the gas barrier film has a plurality of inorganic layers, the inorganic layers may be formed of the same material or different materials. However, in view of productivity and the like, it is preferable that all the inorganic layers are formed of the same material,

The organic layer 28 is provided on the inorganic layer 26.

As described above, the organic layer 28 is a layer functioning as a protective layer for the inorganic layer 26. In a case where the organic layer 28 is provided as an uppermost layer, the damage of the inorganic layer 26 exhibiting gas barrier properties can be prevented, and hence the gas barrier layer 14 can stably exhibit intended gas barrier properties.

The organic layer 28 is basically the same as the aforementioned organic layer 24.

The thickness of the gas barrier layer 14 may be appropriately set according to the thickness of the laminated film 10, the size of the laminated film 10, and the like.

According to the examination performed by the inventors of the present invention, the thickness of the gas barrier layer 14 is preferably 5 to 100 μm, more preferably 10 to 70 μm, and particularly preferably 15 to 55 μm.

In a case where the thickness of the gas barrier layer 14 is equal to or smaller than 100 μm, it is possible to prevent the gas barrier layer 14, that is, the laminated film 10 from becoming unnecessarily thick. Furthermore, it is preferable that the thickness of the gas barrier layer 14 is equal to or greater than 5μm, because then the thickness of the functional layer 12 can be made uniform at the time of forming the functional layer 12 between two gas barrier layers 14.

As described above, the laminated film 10 has a constitution in which the gas barrier layer 14 is laminated on both surfaces of the functional layer 12, and the entirety of the cross section of the laminate end consisting of the functional layer 12 and the gas barrier layers 14 is sealed with the end face sealing layer 16.

In the following description, the laminate consisting of the functional layer 12 and the gas barrier layers 14, that is, the laminate obtained by sandwiching the functional layer 12 between the gas barrier layers 14 will be simply referred to as a laminate as well.

As a preferred aspect, the laminated film 10 illustrated in the drawing has a constitution in which the entirety of the end face of the laminate consisting of the functional layer 12 and the gas barrier layers 14 is sealed with the end face sealing layer 16, but the present invention is not limited thereto.

That is, in a case where the laminated film 10 has a quadrangular planar shape, in the laminated film of the invention, the end face sealing layer may be provided such that the entirety of only two end faces facing each other is covered or provided such that the entirety of three end faces is covered except for one end face. Furthermore, the end face sealing layer may be provided such that each of the end faces of the laminate is partially covered. The way the end face sealing layer is provided may be appropriately set according to the constitution of a backlight unit in which the laminated film is used, the constitution of the portion on which the laminated film is mounted, and the like.

However, the end face sealing layer preferably covers the end face of the laminate in as large area as possible and particularly preferably covers the entirety of the end face of the laminate, because then the deterioration of the functional layer 12 such as the deterioration of quantum dots resulting from oxygen or the like permeating from the end face of the laminate can be more suitably prevented.

In the laminated film 10 of the present invention, the end face sealing layer 16 is a resin layer having an oxygen permeability of equal to or lower than 10 cc(m²·day·atm). In a case where the laminated film 10 of the present invention has such an end face sealing layer 16, a member performing an optical function, such as a quantum dot, is prevented from deteriorating due to oxygen or the like permeating the functional layer 12 from the end face not being covered with the gas barrier layer 14, and the end face sealing layer 16 has sufficient durability even in an environment with a high temperature and a high humidity. Accordingly, it is possible to realize a laminated film having long service life in which the functional layer 12 demonstrates an intended performance over a long period of time.

As described above, in a quantum dot film having a quantum dot layer, in order to prevent quantum dots from deteriorating due to oxygen or the like permeating the quantum dot layer, a gas barrier film is laminated on both surfaces of the quantum dot layer. Furthermore, in order to prevent the permeation of oxygen or the like from the cross section of the laminate end of the quantum dot layer and the gas barrier film, the end face of the laminate is sealed.

The material such as the quantum dot film that is used in a backlight of LCD is highly likely to be exposed to various environments with a high temperature and a high humidity, such as an outdoor environment, an indoor environment, and an in-vehicle environment. Therefore, it is required for the end face of the laminate to be sealed such that the necessary gas barrier properties are exhibited and that high durability preventing deterioration is exhibited even in an environment with a high temperature and a high humidity.

However, in a case where the end face of the quantum dot film is sealed by the method of the related art, although the necessary gas barrier properties are exhibited, sufficient durability against an environment with a high temperature and a high humidity is not obtained.

Generally, the resin having high gas barrier properties is hydrophilic. For example, polyvinyl alcohol (PVA) or the like has a hydrogen bonding functional group. By strengthening the intermolecular interaction, the free volume of the resin is reduced, and high gas barrier properties are exhibited. However, as described above, the material used in a backlight of LCD is highly likely to be exposed to various environments with a high temperature and a high humidity. In the environment with a high temperature and a high humidity, a general resin having high gas barrier properties such as a resin having only a hydrogen bonding functional group has high hydrophilicity, and accordingly, the resin deteriorates. That is, in a case where the end face of a quantum dot film is sealed by the method of the related art, the gas barrier properties and the durability at a high temperature and a high humidity have a trade-off relationship.

In contrast, in the laminated film 10 of the present invention, the end face sealing layer 16 covering the end face of the laminate in which the functional layer 12 is sandwiched between the gas barrier layers 14 is a resin layer having an oxygen permeability of equal to or lower than 10 cc/(m²·day·atm) that is formed of a composition containing a polymerizable compound having a predetermined polymerizable functional group.

That is, in the present invention, as the end face sealing layer 16, a resin layer is used which is formed of a composition containing a polymerizable compound having a predetermined polymerizable functional group and has an oxygen permeability of equal to or lower than 10 cc/(m²·day·atm), and accordingly, sufficient gas barrier properties are obtained. Furthermore, because the resin layer contains a polymerizable compound having a predetermined polymerizable functional group, even though the end face sealing layer 16 is exposed to an environment with a high temperature and a high humidity for a long period of time, the deterioration of the end face sealing layer 16 can be prevented. It is preferable that the end face sealing layer 16 contains a hydrogen bonding compound having a hydrogen bonding functional group, because then the oxygen permeability can be more suitably reduced.

In a case where the oxygen permeability of the end face sealing layer 16 in the laminated film 10 of the present invention is higher than 10 cc/(m²·day·atm), oxygen or the like permeating the functional layer 12 from the end face of the laminate cannot be sufficiently prevented, and hence the functional layer 12 deteriorates within a short time.

Considering the above point, it is preferable that the oxygen permeability of the end face sealing layer 16 is low. Specifically, the oxygen permeability of the end face sealing layer 16 is preferably equal to or lower than 5 cc/(m²·day·atm), and more preferably equal to or lower than 1 cc/(m²·day·atm).

The lower limit of the oxygen permeability of the end face sealing layer 16 is not particularly limited. However, basically, it is preferable that the lower limit of the oxygen permeability is low.

The thickness of the end face sealing layer 16 may be appropriately set according to the material for forming the end face sealing layer 16, such that the oxygen permeability becomes equal to or lower than 10 cc/(m²·day·atm). Herein, the thickness of the end face sealing layer 16 is in other words the length of the end face sealing layer 16 in a direction orthogonal to the end face of the laminate.

According to the examination performed by the inventors of the present invention, the thickness of the end face sealing layer 16 is preferably 0.1 to 500 μm, and more preferably 1 to 100 μm.

It is preferable that the thickness of the end face sealing layer 16 is equal to or greater than 0.1 μm, because then an end face sealing layer 16 can be stably formed which appropriately covers the end face of the laminate and has an oxygen permeability of equal to or lower than 10 cc(m²·day·atm).

it is preferable that the thickness of the end face sealing layer 16 is equal to or smaller than 500 μm, because then it is possible to prevent the laminated film 10 from becoming unnecessarily enlarged and to increase an effective area of a device using the laminated film 10 such as a display area of LCD.

It is preferable that the thickness of the end face sealing layer 16 is greater than the surface roughness Ra of the end face of the laminate provided with the end face sealing layer 16. In a case where the thickness of the end face sealing layer 16 is greater than the surface roughness Ra, it is possible to stably form an appropriate end face sealing layer 16 in the entirety of the necessary region of the end face of the laminate.

Considering the above point, the surface roughness Ra of the end face of the laminate is preferably equal to or smaller than 2 μm, and more preferably equal to or smaller than 1μμm.

In a case where the surface roughness Ra of the end face of the laminate is equal to or smaller than 2μm, even with a thin end face sealing layer 16, the entirety of the necessary region of the end face of the laminate can be stably sealed.

The surface roughness Ra (arithmetic mean roughness Ra) may be measured based on JIS B 0601.

The end face sealing layer 16 described above, that is, the resin layer sealing the end face of the laminate can be formed of various known resin materials that can form the end face sealing layer 16 having an oxygen permeability of equal to or lower than 10 cc/(m²·day·atm).

Generally, the end face sealing layer 16 is formed by preparing a composition, which contains a compound (a monomer, a dimer, a trimer, an oligomer, a polymer, or the like) that is mainly formed into the end face sealing layer 16, that is, a resin layer, additives that are added if necessary such as a cross-linking agent and a surfactant, an organic solvent, and the like, coating a deposition surface for the end face sealing layer 16 with the composition, drying the composition, and, if necessary, polymerizing (cross-linking-curing) the compound mainly constituting the resin layer by ultraviolet ray irradiation, heating, or the like.

The composition for forming the end face sealing layer 16, that is, a resin layer in the laminated film 10 of the present invention contains a polymerizable compound or additionally contains a hydrogen bonding compound. The polymerizable compound is a compound having polymerization properties, and the hydrogen bonding compound is a compound having hydrogen bonding properties.

Basically, the end face sealing layer 16, that is, the resin layer is mainly formed of a polymerizable compound or a hydrogen bonding compound which may be additionally used. A logP value of a degree of hydrophilicity of the polymerizable compound and the hydrogen bonding compound contained in the composition for forming the end face sealing layer 16 is preferably equal to or smaller than 4, and more preferably equal to or smaller than 3.

In the present invention, the LogP value of a degree of hydrophilicity is a logarithm of a partition coefficient of 1-octanol/water. The LogP value can be calculated by a fragment method, an atomic approach method, and the like. The LogP value described in the present specification is a LogP value calculated from the structure of a compound by using ChemBioDraw Ultra 12.0 manufactured by CambridgeSoft Corporation.

As described above, generally, the functional layer 12 is obtained by dispersing a material performing an optical function in a resin that becomes a matrix.

In many cases, a hydrophobic resin is used as a matrix for the functional layer 12. Particularly, in a case where the functional layer 12 is a quantum dot layer, a hydrophobic resin is frequently used as a matrix.

Basically, in the laminated film of the present invention in which a resin layer is used as the end face sealing layer 16, the adhesion between the functional layer 12, which is obtained by dispersing quantum dots and the like in a resin that becomes a matrix, and the end face sealing layer 16 is strong. In order to further strengthen the adhesion between the end face sealing layer 16 and the functional layer 12 in which a hydrophobic matrix is used, it is preferable that the end face sealing layer 16 is formed of a hydrophobic compound.

As it is also known, the smaller the logP value of a degree of hydrophilicity of a compound, the higher the hydrophilicity of the compound. That is, in order to form an end face sealing layer 16 having strong adhesion with respect to the functional layer 12, it is preferable that the polymerizable compound or the hydrogen bonding compound as a main component of the end face sealing layer 16 has a large logP value of a degree of hydrophilicity.

In contrast, a resin formed of a compound having high hydrophobicity has a high oxygen permeability. Therefore, in view of the oxygen permeability of the resin layer, it is preferable that the polymerizable compound or the hydrogen bonding compound as a main component of the resin layer has a small logP value of a degree of hydrophilicity.

Accordingly, in a case where the end face sealing layer 16 is formed using a polymerizable compound and a hydrogen bonding compound having a logP value of a degree of hydrophilicity of equal to or smaller than 4, it is possible to form en end face sealing layer 16 having a sufficiently low oxygen permeability with securing strong adhesion with respect to the functional layer 12 by appropriate hydrophobicity.

In view of the oxygen permeability, it is preferable that the polymerizable compound and the hydrogen bonding compound have a small logP value of a degree of hydrophilicity. However, in a case where the logP value of a degree of hydrophilicity is too small, the hydrophilicity may be too high, the adhesion between the end face sealing layer 16 and the functional layer 12 may be weakened, and the durability of the end face sealing layer 16 may deteriorate.

Considering the above points, the logP value of a degree of hydrophilicity of the polymerizable compound and the hydrogen bonding compound is preferably equal to or greater than 0.0, and more preferably equal to or greater than 0.5.

The composition forming the end face sealing layer 16 in the laminated film 10 of the present invention contains the hydrogen bonding compound, preferably in an amount of equal to or greater than 30 parts by mass and more preferably in an amount of equal to or greater than 40 parts by mass provided that the total amount of solid contents of the composition is 100 parts by mass.

The total amount of solid contents of the composition is the total amount of components that should remain in the end face sealing layer 16 to be formed, except for an organic solvent in the composition.

It is preferable that the solid contents in the composition forming the end face sealing layer 16 contain a hydrogen bonding compound in an amount of equal to or greater than 30 parts by mass, because then the oxygen permeability can be reduced by strengthening the intermolecular interaction or the like.

A hydrogen bond refers to a non-covalent bond that is formed between a hydrogen atom, which forms a covalent bond with an atom having electronegativity higher than that of the hydrogen atom in a molecule, and another atom or atomic group in the same molecule or different molecules by attractive interaction.

The functional group having hydrogen bonding properties is a functional group containing a hydrogen atom which can form such a hydrogen bond. Specific examples of the functional group include a urethane group, a urea group, a hydroxyl group, a carboxyl group, an amide group, a cyano group, and the like.

Specific examples of compounds having these functional groups include monomers and oligomers which are obtained by reacting diisocyanate such as tolylene diisocyanate (TDI), diphenylmethane diisocyanate (MDI), hexamethylene diisocyanate (HDI), isophorone diisocyanate (IPDI), and hydrogenated MDI (HMDI) with polyol such as poly(propyleneoxide)diol, poly(tetramethyleneoxide)diol, ethoxylated bisphenol A, ethoxylated bisphenol S spiroglycol, caprolactone-modified diol, and carbonate diol and hydroxyacrylate such as 2-hydroxyethyl (meth)acrylate, 2-hydroxypropyl (meth)acrylate, glycidyl di(meth)acrylate, and pentaerythritol triacrylate.

Examples of the aforementioned compounds also include an epoxy compound obtained by reacting a compound having an epoxy group with a compound such as a bisphenol A-type compound, a bisphenol S-type compound, a bisphenol F-type compound, an epoxidized oil-type compound, and a phenol novolac-type compound and an epoxy compound obtained by reacting alicyclic epoxy with an amine compound, an acid anhydride, and the like.

Examples of the aforementioned compounds also include a cationically polymerized substance of the aforementioned epoxy compound, polyvinyl alcohol (PVA), an ethylene-vinyl alcohol copolymer (EVOH), a butenediol-vinyl alcohol copolymer, polyacrylonitrile, and the like.

Among these, a compound having an epoxy group and a compound obtained by reacting a compound having an epoxy group are preferable, because these compounds less experience cure shrinkage and have excellent adhesiveness with respect to the laminated film.

The composition forming the end face sealing layer 16 in the laminated film 10 of the present invention contains a polymerizable compound having at least one polymerizable functional group selected from a (meth)acryloyl group, a vinyl group, a glycidyl group, an oxetane group, and an alicyclic epoxy group, in an amount of equal to or greater than 5 parts by mass provided that the total amount of solid contents of the composition is 100 parts by mass. The composition contains the polymerizable compound having the aforementioned polymerizable functional group preferably in an amount of equal to or greater than 10 parts by mass.

In a case where the composition forming the end face sealing layer 16 in the laminated film 10 of the present invention contains the polymerizable compound having at least one polymerizable functional group selected from a (meth)acrylate and the like in an amount of equal to or greater than 5 parts by mass, an end face sealing layer 16 having excellent durability at a high temperature and a high humidity is realized.

Specific examples of the polymerizable compound having a (meth)acryloyl group include neopentyl glycol di(meth)acrylate, 1,9-nonanediol di(meth)acrylate, tripropylene glycol di(meth)acrylate, ethylene glycol di(meth)acrylate, dicyclopentenyl (meth)acrylate, dicyclopentenyloxyethyl (meth)acrylate, dicyclopentanyl di(meth)acrylate, and the like.

Specific examples of the polymerizable compound having a glycidyl group, an oxetane group, an alicyclic epoxy group, or the like include bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, glycerin triglycidyl ether, trimethylolpropane triglycidyl ether, and the like.

In the present invention, as the polymerizable compound having a (meth)acryloyl group or a glycidyl group, commercially available products can be suitably used.

As the commercially available products including the polymerizable compound, MAXIVE manufactured by MITSUBISHI GAS CHEMICAL COMPANY, INC, NANOPOX 450, NANOPOX 500, and NANOPOX 630 manufactured by Evonik Industries, a series compounds such as COMPOCERAN 102 manufactured by Arakawa Chemical Industries, Ltd, FLEP and THIOKOL LP manufactured by Toray Fine Chemicals Co., Ltd, a series of compounds such as LOCTITE E-30CL manufactured by Henkel Japan Ltd, a series of compounds such as EPO-TEX353ND manufactured by Epoxy Technology Inc, and the like can be suitably exemplified.

If necessary, the composition forming the end face sealing layer 16 in the laminated film of the present invention may contain a polymerizable compound which does not contain a (meth)acryloyl group, a vinyl group, a glycidyl group, an oxetane group, and an alicyclic epoxy group.

Here, provided that the total amount of solid contents of the composition forming the end face sealing layer 16 is 100 parts by mass, the amount of the polymerizable compound, which does not contain the above functional groups, contained in the composition is preferably equal to or smaller than 3 parts by mass.

In the laminated film 10 of the present invention, particles of an inorganic substance (particles formed of an inorganic compound) may be dispersed in the end face sealing layer 16.

In a case where the end face sealing layer 16 contains the particles of an inorganic substance, the oxygen permeability of the end face sealing layer 16 can be further reduced, and the deterioration of the functional layer 12 resulting from oxygen or the like permeating from the end face can be more suitably prevented.

The size of the particles of an inorganic substance dispersed in the end face sealing layer 16 is not particularly limited, and may be appropriately set according to the thickness of the end face sealing layer 16 or the like.

The region of the end face sealing layer 16 in the plane direction of the laminated film 10 becomes an ineffective area at the time of incorporating the laminated film 10 into a device such as a backlight. Furthermore, at the time of incorporating the laminated film 10 into a device, the end face of the laminated film 10, that is, the end face of the end face sealing layer 16 preferably is in a planar state.

Considering the above point, the size (maximum length) of the particles of an inorganic substance dispersed in the end face sealing layer 16 is preferably less than the thickness of the end face sealing layer 16. Particularly, the smaller the size of the particles, the more advantageous.

The size of the particles of an inorganic substance dispersed in the end face sealing layer 16 may be uniform or non-uniform.

The content of the particles of an inorganic substance in the end face sealing layer 16 may be appropriately set according to the size of the particles of an inorganic substance or the like.

According to the examination performed by the inventors of the present invention, the content of the particles of an inorganic substance in the end face seating layer 16 is preferably equal to or smaller than 50% by mass, and more preferably 10% to 30% by mass. That is, provided that the total amount of solid contents in the composition forming the end face sealing layer 16 is 100 parts by mass, the content of the particles of an inorganic substance is preferably equal to or smaller than 50 parts by mass, and more preferably 10 to 30 parts by mass.

The greater the content of the particles of an inorganic substance is, the more the oxygen permeability of the end face sealing layer 16 is effectively reduced by the particles of an inorganic substance. In a case where the content of the particles of an inorganic substance is equal to or greater than 10% by mass, the effect obtained by the addition of the particles of an inorganic substance becomes more suitable, and an end face sealing layer 16 having a low oxygen permeability can be formed.

It is preferable that the content of the particles of an inorganic substance in the end face sealing layer 16 is equal to or smaller than 50% by mass, because then the adhesiveness or the durability of the end face sealing layer 16 can become sufficient, and the occurrence of cracking at the time of cutting or punching the laminated film can be inhibited.

Specific examples of the particles of an inorganic substance dispersed in the end face sealing layer 16 include silica particles, alumina particles, silver particles, copper particles, and the like.

The laminated film of the present invention can be prepared by a known method. As a preferred method, the following method can be exemplified.

First, as described above, the organic layer 24 is formed on the surface of the support 20 by a coating method or the like, and the inorganic layer 26 is formed on the surface of the organic layer 24 by plasma CVD or the like. Then, the organic layer 28 is formed on the surface of the inorganic layer 26 by a coating method or the like, thereby preparing the gas barrier layer 14 (gas barrier film).

It is preferable that the formation of the organic layer and the inorganic layer is performed by a so-called roll-to-roll method. In the following description, “roll-to-roll” will be referred to as “RtoR” as well.

Meanwhile, a composition is prepared which contains an organic solvent, a compound forming a resin to be a matrix, quantum dots and the like and becomes the functional layer 12 such as a quantum dot layer.

Two sheets of gas barrier layers 14 are prepared, and the surface of the organic layer 28 of one of the gas barrier layers 14 is coated with the composition that becomes the functional layer 12. Furthermore, the other sheet of gas barrier layer 14 is laminated on the composition in a state where the organic layer 28 faces the composition side, and ultraviolet curing or the like is performed, thereby preparing a laminate in which the gas barrier layer 14 is laminated on both surfaces of the functional layer 12.

The prepared laminate is cut in a predetermined size, and a plurality of, for example, 1,000 sheets of the cut laminates are stacked. Then, the entirety of the end face of the stacked laminates is coated with the composition that forms the end face sealing layer 16 described above. Herein, the composition preferably has high viscosity, and may be in the form of paste.

Thereafter, the composition with which the end face of the laminates was coated was dried, and if necessary, the composition is cured by being irradiated with ultraviolet rays or the like.

Subsequently, the stacked laminates are separated one by one, thereby preparing the laminated film 10 including the end face sealing layer 16 formed on the end face of the laminate in which the gas barrier layer 14 is laminated on both surfaces of the functional layer 12.

Hitherto, the laminated film of the present invention has been specifically described, but the present invention is not limited to the above examples. It goes without saying that the present invention may be ameliorated or modified in various ways within a scope that does not depart from the gist of the present invention.

### EXAMPLES

Hereinafter, the present invention will be more specifically described based on specific examples of the present invention. The present invention is not limited to the examples described below, and the materials, the amount and proportion of the materials used, the treatment content, the treatment sequence, and the like shown in the following examples can be appropriately modified as long as the modification does not depart from the gist of the present invention.

<Preparation of Gas Barrier Layer 14>

<<Support 20>>

As the support 20 of the gas barrier layer 14, a polyethylene terephthalate film (PET film, manufactured by Toyobo Co., Ltd, trade name: COSMOSHINE A4300, thickness: 50 μm, width: 1,000 mm, length: 100 m) was used.

<<Formation of Organic Layer 24>>

The organic layer 24 was formed on one surface of the support 20 as below.

First, a composition for forming the organic layer 24 was prepared. Specifically, trimethylolpropane triacrylate (TMPTA, manufactured by Daicel SciTech) and a photopolymerization initiator (manufactured by Lamberti S.p.A, ESACURE KTO46) were prepared, weighed such that a mass ratio of TMPTA:photopolymerization initiator became 95:5, and dissolved in methyl ethyl ketone, thereby preparing a composition with a concentration of solid contents of 15%.

By using the composition, the organic layer 24 was formed on one surface of the support 20 by a general film forming device which forms a film by a coating method using RtoR.

First, by using a die coater, one surface of the support 20 was coated with the composition. The support 20 having undergone coating was passed through a drying zone with a temperature of 50° C. for 3 minutes and then irradiated with ultraviolet rays (cumulative irradiation amount: about 600 mJ/cm²) such that the composition was cured, thereby forming the organic layer 24.

Furthermore, in the pass roll obtained immediately after the ultraviolet ray curing, as a protective film, a polyethylene film (PE film, manufactured by Sun A Kaken Co., Ltd., trade name: PAC 2-30-T) was bonded to the surface of the organic layer 24, and the resulting film was transported and wound up.

The thickness of the formed organic layer 24 was 1 μm.

<<Formation of Inorganic Layer 26>>

Then, by using a CVD device using RtoR, the inorganic layer 26 (silicon nitride (SiN) layer) was formed on the surface of the organic layer 24.

The support 20 on which the organic layer 24 was formed was fed from a feeding machine, and before an inorganic layer was formed, the protective film was peeled off after the laminate passed the last film surface-touching roll. Then, on the exposed organic layer 24, the inorganic layer 26 was formed by plasma CVD.

For forming the inorganic layer 26, as raw material gases, silane gas (flow rate: 160 sccm), ammonia gas (flow rate: 370 sccm), hydrogen gas (flow rate: 590 sccm), and nitrogen gas (flow rate: 240 sccm) were used. As a power source, a high-frequency power source having a frequency of 13.56 MHz was used. The film forming pressure was 40 Pa.

The thickness of the formed inorganic layer 26 was 50 nm.

<<Formation of Organic Layer 28>>

Furthermore, the organic layer 28 was laminated on the surface of the inorganic layer 26 as below.

First, a composition for forming the organic layer 28 was prepared. Specifically, a urethane bond-containing acryl polymer (manufactured by TAISEI FINE CHEMICAL CO., LID., ACRIT 8BR500, mass-average molecular weight: 250,000) and a photopolymerization initiator (IRGACURE 184 manufactured by BASF SE) were prepared, weighed such that a mass ratio of urethane bond-containing acryl polymer:photopolymerization initiator became 95:5, and dissolved in methyl ethyl ketone, thereby preparing a composition with a concentration of solid contents of 15% by mass.

By using the composition, the organic layer 28 was formed on the surface of the inorganic layer 26 by using a general film forming device that forms a film by a coating method using RtoR.

First, by using a die coater, one surface of the support 20 was coated with the composition. The support 20 having undergone coating was passed through a drying zone with a temperature of 100° C. for 3 minutes, thereby forming the organic layer 28.

In this way, the gas barrier layer 14 (gas barrier film) shown in FIG. 2 was prepared in which the organic layer 24, the inorganic layer 26, and the organic layer 28 were formed on the support 20. The thickness of the formed organic layer 28 was 1 μm.

In the pass roll obtained immediately after drying of the composition, as a protective film, a polyethylene film was bonded to the surface of the organic layer 28 in the same manner as described above, and then the gas barrier layer 14 was wound up.

<Preparation of Laminate>

A composition having the following makeup was prepared which was for forming a quantum dot layer as the functional layer 12.

(Makeup of Composition)

| | | |
|---|---|---|
| Toluene dispersion liquid of quantum dot 1 | 10 | parts by mass |
| (emission maximum: 520 nm) | | |
| Toluene dispersion liquid of quantum dot 2 | 1 | part by mass |
| (emission maximum: 630 mm) | | |
| Lauryl methacrylate | 2.4 | parts by mass |
| Trimethylolpropane triacrylate | 0.54 | parts by mass |
| Photopolymerization initiator (IRGACURE | 0.009 | parts by mass |
| 819 (manufactured by BASF SE)) | | |

As the quantum dots 1 and 2, the following nanocrystals having a core-shell structure (InP/ZnS) were used.

Quantum dot 1: INP 530-10 (manufactured by NN-LABS, LLC)
Quantum dot 2: INP 620-10 (manufactured by NN-LABS, LLC)

The viscosity of the prepared composition was 50 mPa·s.

By using the composition and a general film forming device that forms a film by a coating method using RtoR, a laminate was prepared in which the gas barrier layer 14 was laminated on both surfaces of the functional layer 12.

Two sheets of gas barrier layers 14 were loaded on the film forming device at a predetermined position and transported. First, the protective film of one of the gas barrier layers was peeled, and then the surface of the organic layer 28 was coated with the composition by using a die coater. Thereafter, the protective film was peeled from the other gas barrier layer 14, and then the gas barrier layers 14 was laminated in a state where the organic layer 28 faced the composition.

Furthermore, the laminate in which the composition that became the functional layer 12 was sandwiched between the gas barrier layers 14 was irradiated with ultraviolet rays (cumulative irradiation amount: about 2,000 mJ/cm²), such that the composition was cured, and that the functional layer 12 was formed. In this way, a laminate was prepared in which the gas barrier layer 14 was laminated on both surfaces of the functional layer 12.

### EXAMPLES AND COMPARATIVE EXAMPLES

By using a Thomson blade with a blade edge angle of 17°, the laminate was cut in the form of a sheet with A4 size. Then, 1,000 sheets of the cut laminates were stacked.

### Example 1

As a composition forming the end face sealing layer 16, a composition containing solid contents having the following makeup was prepared. Herein, the makeup is represented by part by mass that is determined in a case where the total solid content is regarded as being 100 parts by mass.

| | |
|---|---|
| Main agent of two liquid curable epoxy | 66.7 parts by mass |
| compound (polymerizable compound, logP | |
| value of degree of hydrophilicity = 3.8, | |
| manufactured by Henkel Japan Ltd, main | |
| agent of LOCTITE E-30CL) | |
| Curing agent of two liquid curable epoxy | 33.3 parts by mass |
| compound (manufactured by Henkel Japan | |
| Ltd, curing agent of LOCTITE E-30CL) | |

By using a dispenser, the entirety of the end face of the stacked 1,000 sheets of laminates was coated with the composition, and the composition was dried and cured for 10 minutes at 80° C., thereby forming the end face sealing layer 16.

Then, each of the laminates was peeled, thereby preparing the laminated film 10 shown in FIG. 1 including end face sealing layer 16 formed on the end face of the laminate in which the gas barrier layer 14 was laminated on both surfaces of the functional layer 12.

The thickness of the end face sealing layer 16 was 60 μm.

Furthermore, on a biaxially oriented polyester film (manufactured by TORAY INDUSTRIES, INC., LUMIRROR T60) having a thickness of 100 μm, a sample for measuring oxygen permeability having a thickness of 60 μm was prepared in the completely same manner as used for preparing the end face sealing layer 16. Then, the sample for measuring oxygen permeability was peeled from the polyester film, and by using a measurement instrument (manufactured by NIPPON API CO., LTD.) adopting an APIMS method (atmospheric pressure ionization mass spectrometry), the oxygen permeability was measured under the condition of a temperature of 25° C. and a humidity of 60% RH.

As a result, the oxygen permeability of the sample for measuring oxygen permeability, that is, the end face sealing layer 16 was 5.1 cc/(m²·day·atm).

### Example 2

The laminated film 10 was prepared in the same manner as in Example 1, except that the makeup of the solid contents of the composition that became the end face sealing layer 16 was changed as below.

| | |
|---|---|
| Alicyclic epoxy compound (polymerizable | 50 parts by mass |
| compound, logP value of degree of | |
| hydrophilicity = 0.8, manufactured by | |
| Daicel Corporation, CELLOXIDE 2021P) | |
| Phthalic anhydride | 50 parts by mass |

The oxygen permeability of the end face sealing layer 16 was measured in the same manner as in Example 1. As a result, the oxygen permeability was 4.6 cc/(m²·day·atm).

### Example 3

The laminated film 10 was prepared in the same manner as in Example 1, except that the makeup of the solid contents of the composition that became the end face sealing layer 16 was changed as below.

| | | |
|---|---|---|
| UV curable isocyanate compound (polymerizable | 14 | parts by mass |
| compound, logP value of degree of | | |
| hydrophilicity = 0.5, manufactured by SHOWA | | |
| DENKO K.K., KARENZ moi) | | |
| Polyvinyl alcohol (hydrogen bonding compound, | 83 | parts by mass |
| logP value of degree of hydrophilicity = 0.9, | | |
| manufactured by KURARAY CO., LTD., PVA | | |
| 117H) | | |
| Photoradical polymerization initiator | 3 | parts by mass |
| (manufactured by BASF SE, IRGACURE 184) | | |

In the present example, coating and drying of the composition that became the end face sealing layer 16 were performed, and then the composition was cured by being irradiated with ultraviolet rays (cumulative irradiation amount: about 800 mJ/cm²), thereby forming the end face sealing layer 16.

The oxygen permeability of the end face sealing layer 16 was measured in the same manner as in Example 1. As a result, the oxygen permeability was 0.8 cc/(·day·atm).

### Example 4

The laminated film 10 was prepared in the same manner as in Example 1, except that the makeup of the solid contents of the composition that became the end face sealing layer 16 was changed as below.

| | | |
|---|---|---|
| Main agent of two liquid curable epoxy compound | 50 | parts by mass |
| (polymerizable compound, logP value of degree | | |
| of hydrophilicity = 3.8, manufactured by Henkel | | |
| Japan Ltd, main agent of LOCTITE E-30CL) | | |
| Curing agent of two liquid curable epoxy | 25 | parts by mass |
| compound (manufactured by Henkel Japan Ltd, | | |
| curing agent of LOCTITE E-30CL) | | |
| Silica particles (particles of inorganic | 25 | parts by mass |
| substance, particle diameter: 40 to 50 nm, | | |
| manufactured by NISSAN CHEMICAL | | |
| INDUSTRIES, LTD., MEK-AC-4130Y) | | |

The oxygen permeability of the end face sealing layer 16 was measured in the same manner as in Example 1. As a result, the oxygen permeability was 2.5 cc/(m²·day·atm).

### Example 5

The laminated film 10 was prepared in the same manner as in Example 1, except that the makeup of the solid contents of the composition that became the end face sealing layer 16 was changed as below.

| | | |
|---|---|---|
| TMPTA (polymerizable compound, logP value of | 37 | parts by mass |
| degree of hydrophilicity = 2.5, manufactured | | |
| by Daicel SciTech) | | |
| 3,4-Epoxycyclohexylmethyl methacrylate | 57 | parts by mass |
| (hydrogen bonding compound, logP value of | | |
| degree of hydrophilicity = 3.4, manufactured | | |
| by Daicel Corporation, CYCLOMER M100) | | |
| Photoradical polymerization initiator | 3 | parts by mass |
| (manufactured by BASF SE, IRGACURE 184) | | |
| Photocationic polymerization initiator | 3 | parts by mass |
| (CPI-100P, manufactured by San-Apro Ltd.) | | |

In the present example, coating and drying of the composition that became the end face sealing layer 16 were performed, and then the composition was cured by being irradiated with ultraviolet rays (cumulative irradiation amount: about 800 mJ/cm²), thereby forming the end face sealing layer 16.

The oxygen permeability of the end face sealing layer 16 was measured in the same manner as in Example 1. As a result, the oxygen permeability was 9.5 cc/(m²·day·atm).

### Example 6

The laminated film 10 was prepared in the same manner as in Example 1, except that the makeup of the solid contents of the composition that became the end face sealing layer 16 was changed as below.

| | | |
|---|---|---|
| UV curable isocyanate compound (polymerizable | 12 | parts by mass |
| compound, logP value of degree of | | |
| hydrophilicity = 0.5, manufactured by SHOWA | | |
| DENKO K.K., KARENZ moi) | | |
| Poly-vinyl alcohol (hydrogen bonding | 73 | parts by mass |
| compound, logP value of degree of | | |
| hydrophilicity = 0.9, manufactured by | | |
| KURARAY CO., LTD., PVA 117H) | | |
| Photoradical polymerization initiator | 3 | parts by mass |
| (manufactured by BASF SE, IRGACURE 184) | | |
| Silica particles (particles of inorganic | 12 | parts by mass |
| substance, particle diameter: 40 to 50 nm, | | |
| manufactured by NISSAN CHEMICAL | | |
| INDUSTRIES, LTD., MEK-AC-4130Y) | | |

In the present example, coating and drying of the composition that became the end face sealing layer 16 were performed, and then the composition was cured by being irradiated with ultraviolet rays (cumulative irradiation amount: about 800 mJ/cm²), thereby forming the end face sealing layer 16.

The oxygen permeability of the end face sealing layer 16 was measured in the same manner as in Example 1. As a result, the oxygen permeability was 0.6 cc/(m²·day·atm).

### Comparative Example 1

A laminated film was prepared in the same manner as in Example 1, except that the end face sealing layer 16 was not formed.

### Comparative Example 2

A laminated film was prepared in the same manner as in Example 1, except that the makeup of the solid contents of the composition that became an end face sealing layer was changed as below.

| | |
|---|---|
| Lauryl acrylate (polymerizable compound, logP | 50 parts by mass |
| value of degree of hydrophilicity = 5.2, | |
| manufactured by TOKYO CHEMICAL INDUSTRY | |
| CO., LTD.) | |
| Polyvinyl alcohol (hydrogen bonding compound, | 50 parts by mass |
| logP value of degree of hydrophilicity = 0.9, | |
| manufactured by KURARAY CO., LTD., PVA 117H) | |

The oxygen permeability of the end face sealing layer 16 was measured in the same manner as in Example 1. As a result, the oxygen permeability was 75 cc/(m²·day·atm).

In the present example, coating and drying of the composition that became the end face sealing layer 16 were performed, and then the composition was cured by being irradiated with ultraviolet rays (cumulative irradiation amount: about 800 mJ/cm²), thereby forming the end face sealing layer 16.

### Comparative Example 3

A laminated film was prepared in the same manner as in Example 1, except that the makeup of the solid contents of the composition that became an end face sealing layer was changed as below.

| | |
|---|---|
| Polyvinyl alcohol (hydrogen bonding compound, | 100 parts by mass |
| logP value of degree of hydrophilicity = 0.9, | |
| manufactured by KURARAY CO., LTD., PVA 117H) | |

The oxygen permeability of the end face sealing layer 16 was measured in the same manner as in Example 1. As a result, the oxygen permeability was 0.8 cc/(m²·day·atm).

### Comparative Example 4

A laminated film was prepared in the same manner as in Example 1, except that the makeup of the solid contents of the composition that became an end face sealing layer was changed as below.

| | | |
|---|---|---|
| TMPTA (polymerizable compound, logP value of | 97 | parts by mass |
| degree of hydrophilicity = 2.5, manufactured | | |
| by Daicel SciTech) | | |
| Photoradical polymerization initiator | 3 | parts by mass |
| (manufactured by BASF SE, IRGACURE 184) | | |

In the present example, coating and drying of the composition that became the end face sealing layer 16 were performed, and then the composition was cured by being irradiated with ultraviolet rays (cumulative irradiation amount: about 800 mJ/cm²), thereby forming the end face sealing layer 16.

The oxygen permeability of the end face sealing layer 16 was measured in the same manner as in Example 1. As a result, the oxygen permeability was 17 cc/(m²·day·atm).

For the laminated films of Examples 1 to 6 and Comparative Examples 1 to 4 prepared as above, the non-light-emitting region on the edge and the high-temperature and high-humidity resistance of the end face sealing layer 16 were evaluated.

[Non-Light-Emitting Region on Edge]

In a room kept at 25° C. and a relative humidity of 60%, the laminated film was placed on a commercially available blue light source (manufactured by OPTEX-FA CO., Ltd., OPSM-H150X 142B), and the laminated film was continuously irradiated with blue light for 1,000 hours.

The luminance of the laminated film having undergone continuous irradiation was measured using a luminance distribution meter ProMetric (manufactured by Radiant Zemax Inc). The distance at which the luminance was reduced 20% or more compared to the luminance of the center of the laminated film was denoted by an edge deterioration distance L, and the light emitting region on the edge was evaluated based on the following standards.

In a case where the evaluation result is AA to B, it is possible to make a judgment that the emission efficiency of the edge is excellently maintained even after the continuous irradiation.

AA: L≤0.1 mm

A: 0.1 mm<L≤0.3 mm

B: 0.3 mm<L≤0.5 mm

C: 0.5 min<L≤1.5 mm

D: 1.5 mm<L

[High-Temperature and High-Humidity Resistance]

A film thickness D1 of the end face sealing layer 16 of the prepared laminated film was measured using an optical microscope, and then the laminated film was put into a constant-temperature tank kept at 85° C. and a relative humidity of 85% and stored as it was for 300 hours.

The laminated film was taken out of the constant-temperature tank and then humidified for 24 hours in a room kept at 25° C. and a relative humidity of 60%, and a film thickness D2 of the end face sealing layer 16 of the laminated film having been left in an environment with a high temperature and a high humidity was measured according to the same sequence as described above.

For the end face sealing layer 16 having been left in an environment with a high temperature and a high humidity, a change of film thickness X[%]=(D1−D2)/D2×100 was calculated, and the high-temperature and high-humidity resistance was evaluated based on the following standards.

In a case where the evaluation result is A or B, it is possible to make a judgment that the laminated film has resistance against a high temperature and a high humidity.

A: X≤5%

B: 5%<X≤10%

C: 10%<X≤30%

D: 30%<X

The composition of the end face sealing layer and the evaluation results are shown in the following table.

TABLE 1

| | | | | | | | | Compar- | Compar- | Compar- | Compar- |
|---|---|---|---|---|---|---|---|---|---|---|---|
| | | | | | | | | ative | ative | ative | ative |
| | | Exam- | Exam- | Exam- | Exam- | Exam- | Exam- | Exam- | Exam- | Exam- | Exam- |
| | | ple 1 | ple 2 | ple 3 | ple 4 | ple 5 | ple 6 | ple 1 | ple 2 | ple 3 | ple 4 |
| Polymer- | Material | Two | Alicyclic | UV | Two | TMPTA | UV | — | Lauryl | — | TMPTA |
| izable | | liquid | epoxy | curable | liquid | | curable | | acrylate | | |
| compound | | curable | | isocyanate | curable | | isocyanate | | | | |
| | | epoxy | | | epoxy | | | | | | |
| | | main | | | main | | | | | | |
| | | agent | | | agent | | | | | | |
| | LogP | 3.8 | 0.8 | 0.5 | 3.8 | 2.5 | 0.5 | | 5.2 | | 2.5 |
| | Part by | 66.7 | 50 | 14 | 50 | 37 | 12 | | 50 | | 97 |
| | mass | | | | | | | | | | |
| Hydrogen | Material | — | — | PVA | — | Acrylate | PVA | — | PVA | PVA | — |
| bonding | LogP | | | 0.9 | | 1.4 | 0.9 | | 0.9 | 0.9 | |
| compound | Part by | | | 83 | | 57 | 73 | | 50 | 100 | |
| | mass | | | | | | | | | | |
| Other | Material | Two | Phthalic | Photo- | Two | Photo- | Photo- | — | — | — | Photo- |
| compounds | | liquid | anhydride | radical | liquid | radical | radical | | | | radical |
| | | curable | | polymer- | curable | polymer- | polymer- | | | | polymer- |
| | | epoxy | | ization | epoxy | ization | ization | | | | ization |
| | | curing | | initiator | curing | initiator | initiator | | | | initiator |
| | | agent | | | agent | | | | | | |
| | Part by | 33.3 | 50 | 3 | 25 | 3 | 3 | | | | 3 |
| | mass | | | | | | | | | | |
| Other | Material | — | — | — | — | Photo- | — | — | — | — | — |
| compounds | | | | | | cationic | | | | | |
| | | | | | | polymer- | | | | | |
| | | | | | | ization | | | | | |
| | | | | | | initiator | | | | | |
| | Part by | | | | | 3 | | | | | |
| | mass | | | | | | | | | | |
| Inorganic | Material | — | — | — | Silica | — | Silica | — | — | — | — |
| particles | | | | | particles | | particles | | | | |
| | Part by | | | | 25 | | 12 | | | | |
| | mass | | | | | | | | | | |

| | | | | | | | | | | |
|---|---|---|---|---|---|---|---|---|---|---|
| Film thickness of end | 60.0 | 60.0 | 60.0 | 60.0 | 60.0 | 60.0 | — | 60.0 | 60.0 | 60.0 |
| face sealing layer [μm] | | | | | | | | | | |
| Oxygen permeability of | 5.1 | 4.6 | 0.8 | 2.5 | 9.5 | 0.6 | 100 | 75 | 0.8 | 17 |
| end face sealing layer | | | | | | | | | | |
| [cc/(m² · day · atm)] | | | | | | | | | | |
| Non-light-emitting | B | B | A | A | B | AA | D | C | A | C |
| region on edge | | | | | | | | | | |
| High-temperature and | A | A | B | A | A | B | — | B | D | A |
| high-humidity resistance | | | | | | | | | | |
| of sealing layer | | | | | | | | | | |

In the table, PVA means polyvinyl alcohol.
In Example 5, acrylate is 3,4-epoxycyclohexylmethyl methacrylate.

As shown in Table 1, in the laminated film of the present invention, the light-emitting region on the edge is larger than in comparative examples. That is, in the laminated film of the present invention, the deterioration of quantum dots resulting from the permeation of oxygen or the like from the end face can be prevented, and the high-temperature and high-humidity resistance of the end face sealing layer 16 is high.

The above results clearly show the effects of the present invention.

### Explanation of References

10: laminated film
12: (optically) functional layer
14: gas barrier layer
16: end face sealing layer
20: support
24, 28: organic layer
26: inorganic layer

What is claimed is:

1. A laminated film comprising:
an optically functional layer;
a gas barrier layer laminated on at least one main surface of the optically functional layer; and
an end face sealing layer covering at least a portion of a cross section of a laminate end obtained by laminating the optically functional layer and the gas barrier layer,
wherein the end face sealing layer is a resin layer which is formed of a composition containing a polymerizable compound having at least one polymerizable functional group selected from a (meth)acryloyl group, a vinyl group, a glycidyl group, an oxetane group, and an alicyclic epoxy group in an amount of equal to or greater than 5 parts by mass provided that a total amount of solid contents of the composition is 100 parts by mass, and has an oxygen permeability of equal to or lower than 10 cc/(m²·day·atm).

2. The laminated film according to claim 1,
wherein the end face sealing layer covers the entirety of the end face of the laminate.

3. The laminated film according to claim 1,
wherein a logP value of a degree of hydrophilicity of the polymerizable compound contained in the composition forming the end face sealing layer is equal to or smaller than 4.

4. The laminated film according to claim 1,
wherein the composition forming the end face sealing layer contains a hydrogen bonding compound having the logP value of a degree of hydrophilicity of equal to or smaller than 4.

5. The laminated film according to claim 1,
wherein the composition forming the end face sealing layer contains the hydrogen bonding compound in an amount of equal to or greater than 30 parts by mass provided that the total amount of solid contents of the composition is 100 parts by mass.

6. The laminated film according to claim 1,
wherein a thickness of the end face sealing layer is 0.1 to 500 μm.

7. The laminated film according to claim 1,
wherein particles of an inorganic substance are dispersed in the end face sealing layer.

8. The laminated film according to claim 7,
wherein a size of the particles of an inorganic substance is equal to or smaller than the thickness of the end face sealing layer.
